(19) United States
(12) Patent Application Publication
(10) Pub. No.: US 2016/0023869 A1
(43) Pub. Date: Jan. 28, 2016

(54) ASSEMBLY FOR MOVING A COMPONENT RELATIVE TO A CEILING OF AN ENGINE ENCLOSURE

(71) Applicant: Solar Turbines Incorporated, San Diego, CA (US)

(72) Inventors: Luigi Pedrini, Cimo (CH); Alain Antonietti, Sessa (CH); Antonio Amato, Locarno (IT); Gianni Bernardini, Crodo (IT); Riccardo Giacomini, Verbania (IT)

(73) Assignee: Solar Turbines Incorporated, San Diego, CA (US)

(21) Appl. No.: 14/338,594

(22) Filed: Jul. 23, 2014

(51) Int. Cl. B66D 1/60; B66D 1/28

(52) U.S. Cl. CPC B66D 1/60; B66D 1/28

(57) ABSTRACT

An assembly for moving a component relative to a ceiling of an engine enclosure includes a first-class lever, and a harnessing mechanism. The first-class lever is formed in at least one of the ceiling and a structure disposed above the ceiling. The first-class lever has a first side, and a second side located proximal to an opening defined in the ceiling. The harnessing mechanism includes a flexible link having a first end and a second end. The first end is disposed on the first side and is configured to allow an effort to be applied thereto. The second end is disposed on the second side and is configured to releasably connect with the component. The second end may hoist or lower the component relative to the ceiling in response to the effort and based on a type of effort applied at the first end.

### TECHNICAL FIELD

The present disclosure generally relates to an assembly for moving a component relative to a ceiling of an engine enclosure. More particularly, the present disclosure relates to a hoisting assembly that is installed on an engine enclosure offering tight space constraints.

### BACKGROUND

Engine enclosures may be typically provided with motor driven fans to facilitate ventilation. These fans and motors may be large and/or heavy so as to be manually transported or carried from one location to another. During fitment of such large and/or heavy components to the engine enclosure, it may be difficult to accomplish the movement of such components relative to the engine enclosure.

Further, during service routines or overhaul operations, removal of such large and/or heavy components may become tedious with the presence of other structures located in the vicinity of the engine enclosure. As such, in some cases, engine enclosures offer tight space constraints to movement of such large and/or heavy components.

### SUMMARY OF THE DISCLOSURE

In one aspect of the present disclosure, a hoisting assembly is provided for an engine enclosure having a ceiling and a fan mounted thereto. The ceiling of the engine enclosure has an opening configured for reception of the fan on the ceiling. The assembly includes a housing, a noise attenuation structure, a hollow tube, and a harnessing mechanism. The housing includes a plurality of sidewalls supported on a framework. The noise attenuation structure is disposed within the housing. The hollow tube is disposed within the noise attenuation structure. The hollow tube extends from a sidewall to the opening in the ceiling. Moreover, an end of the hollow tube is disposed above the fan. The harnessing mechanism includes a flexible link disposed proximate to the hollow tube. The harnessing mechanism is operable to suspend the flexible link into the hollow tube to allow a releasable engagement between the flexible link and the fan.

In another aspect of the present disclosure, an assembly for moving a component relative to a ceiling of an engine enclosure is provided. The ceiling of the engine enclosure has an opening that is configured for reception of the component thereabout on the ceiling. The assembly includes a first-class lever, and a harnessing mechanism. The first-class lever is formed in at least one of the ceiling and a structure disposed above the ceiling. The first-class lever has a first side, and a second side located proximal to the opening defined in the ceiling. The harnessing mechanism includes a flexible link having a first end, and a second end. The first end is disposed on the first side and is configured to allow an effort to be applied thereto. The second end is disposed on the second side and configured to releasably connect with the component. The second end is further configured to perform at least one of hoisting and lowering of the component relative to the ceiling in response to the effort and based on a type of effort applied at the first end.

In another aspect of the present disclosure, a method of moving a component relative to a ceiling of an engine enclosure includes defining a first-class lever in at least one of the ceiling and a structure disposed above the ceiling; and providing a harnessing mechanism including a flexible link, wherein the flexible link includes a first end disposed on a first side of the first-class lever, and a second end disposed on a second side of the first-class lever. The method further includes releasably connecting the second end of the flexible link with the component; and applying an effort to the first end of the flexible link such that the second end is configured to perform at least one of hoisting and lowering of the component relative to the ceiling in response to the effort and based on a type of effort applied at the first end.

Other features and aspects of this disclosure will be apparent from the following description and the accompanying drawings.

### BRIEF DESCRIPTION OF THE DRAWINGS

FIG. 1 is a side perspective view of an exemplary engine enclosure in accordance with an embodiment of the present disclosure;

FIG. 2 is a partially exploded view of the exemplary engine enclosure showing a gas turbine engine disposed therein and employing an assembly;

FIG. 3 is a front sectional view of the engine enclosure showing internal details of the assembly in accordance with an embodiment of the present disclosure;

FIG. 4 is a diagrammatic illustration of the engine enclosure showing a manner of using the assembly in accordance with an embodiment of this disclosure;

FIG. 5 is a front sectional view of the assembly showing bearings used therein; and

FIG. 6 is a flowchart of a method of moving a component relative to a ceiling of the engine enclosure.

### DETAILED DESCRIPTION

Wherever possible, the same reference numbers will be used throughout the drawings to refer to same or like parts. Moreover, references to various elements described herein are made collectively or individually when there may be more than one element of the same type. However, such references are merely exemplary in nature. It may be noted that any reference to elements in the singular is also to be construed to relate to the plural and vice-versa without limiting the scope of the disclosure to the exact number or type of such elements unless set forth explicitly in the appended claims.

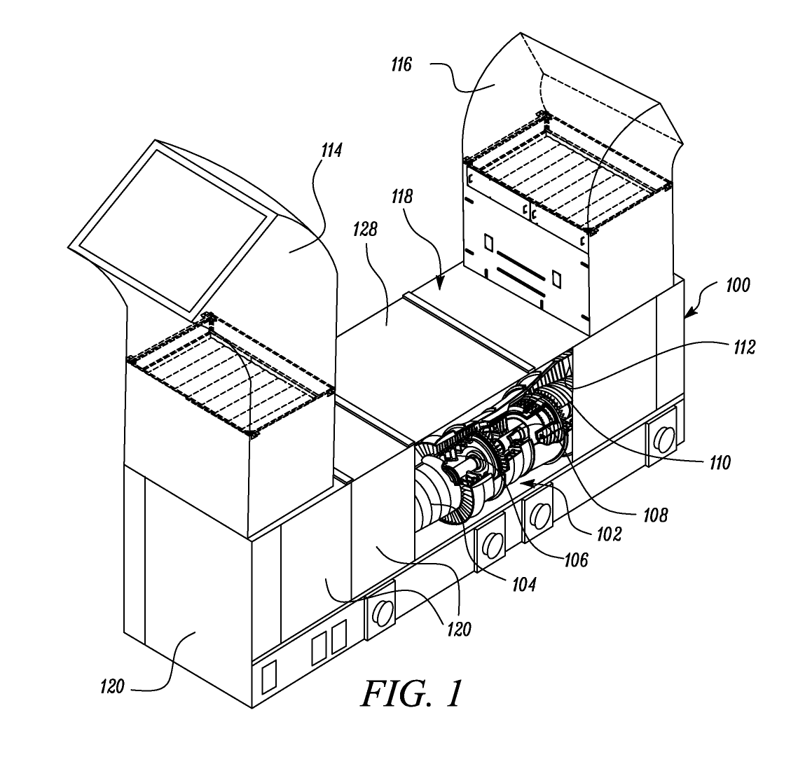

FIG. 1 shows side perspective view of an exemplary engine enclosure 100 in which embodiments of the present disclosure may be implemented. As shown, the engine enclosure 100 may be used to enclose a gas turbine engine 102 therein. However, in alternative embodiments, the engine enclosure 100 may also be used to enclose other types of engines in place of the gas turbine engine 102 disclosed herein. For example, the engine enclosure 100 may be configured to enclose a diesel generator set, an engine and compressor set, or other types of power devices known in the art. Some other examples of engines may include, but are not limited to, reciprocating engines, rotary engines or other type of engines known in the art.

Referring to FIG. 1, the gas turbine engine 102 includes an inlet system 104, a compressor system 106, a combustor system 108, a turbine system 110, and an exhaust system 112. The inlet system 104 is configured to draw and supply air from the atmosphere to the compressor system 106. The compressor system 106 may compress the supplied air and operatively provide the compressed air to various components of the combustor system 108 and the turbine system 110, the compressed air also serving purposes in the gas turbine engine 102 such as, but not limited to, venting, and escaping through the exhaust system 112.

Moreover, the engine enclosure 100 is disposed in fluid communication with an inlet duct system 116 and an outlet duct system 114 that are configured to route air within the engine enclosure 100. The duct systems may accomplish functions such as, but not limited to, maintaining a temperature within the engine enclosure 100, and ventilating the engine enclosure 100 besides other functions known to one skilled in the art.

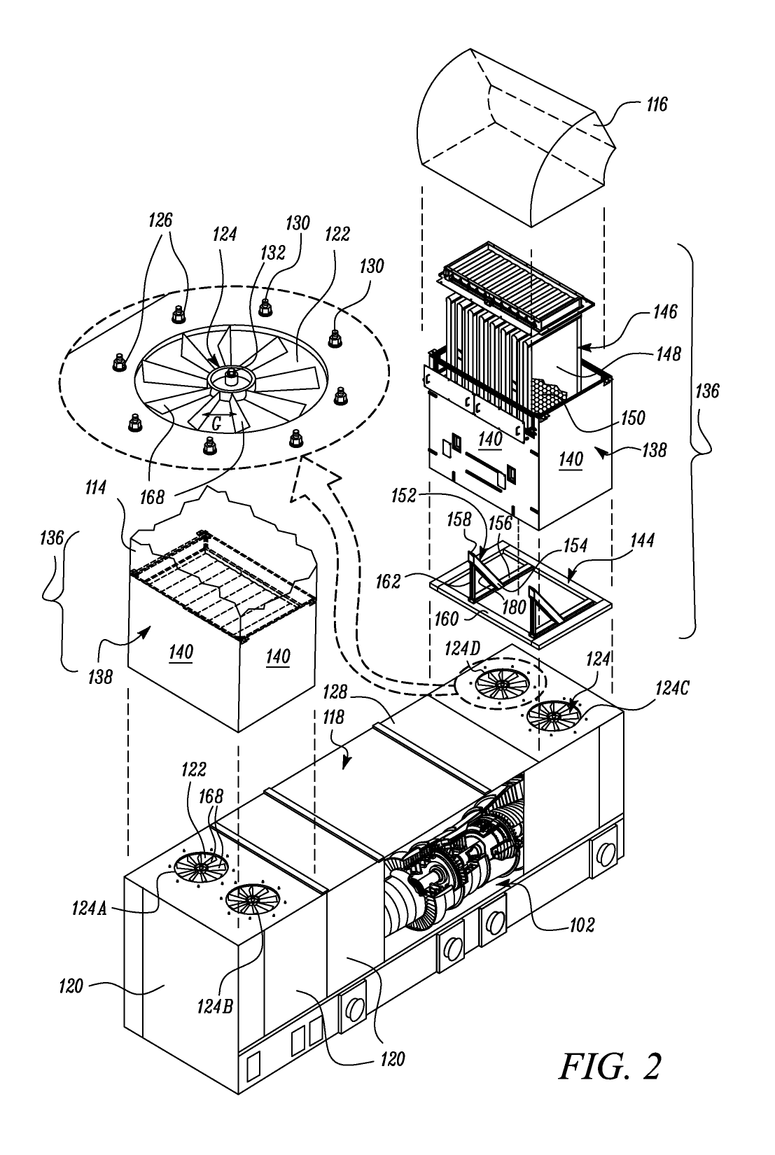

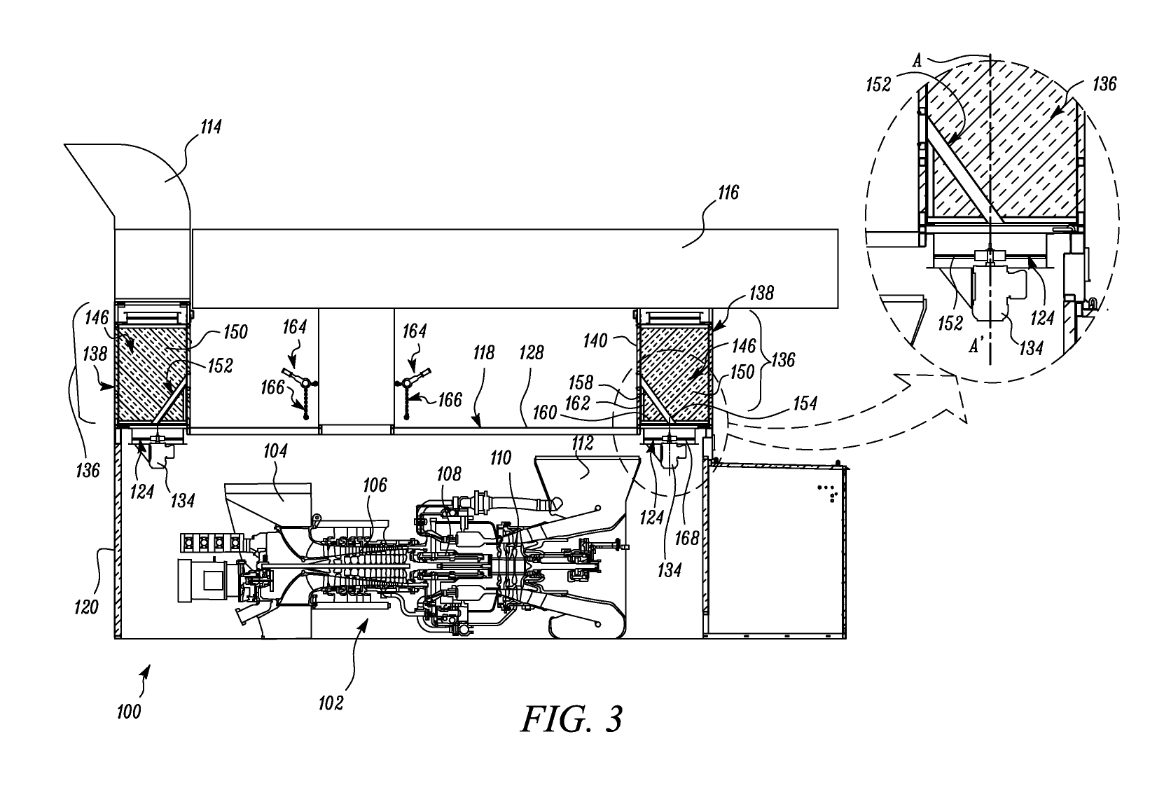

FIG. 2 illustrates a partially exploded view of the exemplary engine enclosure 100. The engine enclosure 100 includes a ceiling 118 supported on multiple sidewalls 120. The ceiling 118 defines a plurality of openings 122 therethrough. The openings 122 are sized and shaped to allow fans 124 to the mount at an underside (not visible in the partially exploded view of FIG. 2) of the ceiling 118. As depicted by an enlarged view in FIG. 2, the ceiling 118 may include nuts 126 welded to a top surface 128 of the ceiling 118 while bolts 130 are received through flanges (not visible) associated with the fans 124. These bolts 130 may then threadably engage with the nuts 126 rigidly disposed on the ceiling 118. Moreover, the fan 124 may include at least one bolt 132 affixed thereon. This bolt 132 may be configured to bear the fan 124 onto a motor 134 provided in association with the fan 124 (See FIG. 3).

Although four openings 122 and four fans 124 are shown in the exemplary embodiment of FIG. 2, one of ordinary skill in the art will acknowledge that any number of fans 124 may be mounted to the ceiling 118 and a corresponding number of openings may be provided in the ceiling 118 to facilitate operation of the fans 124.

In the illustrated embodiment, fans 124a, 124b are provided to correspond with the outlet duct system 114 while fans 124c, 124d are provided to correspond with the inlet duct system 116. The present disclosure relates to a hoisting assembly 136 (hereinafter referred to as ‘assembly 136’) that may be provided to the engine enclosure 100 for accomplishing an attenuation of noise, and for providing support to a movement of the fans 124 relative to the engine enclosure 100. Referring to FIGS. 1 and 2, two assemblies are disposed on the ceiling 118 of the engine enclosure 100. One assembly 136 is disposed between the ceiling 118 and the inlet duct system 116 while another assembly 136 is disposed between the ceiling 118 and the outlet duct system 114.

The assembly 136 includes a housing 138 having sidewalls 140 that are supported on a framework 144 (refer to FIG. 2). The assembly 136 further includes a noise attenuation structure 146 disposed within the housing 138. In the illustrated embodiment, the noise attenuation structure 146 includes a plurality of silencer panels 148 spaced apart from one another and disposed in series within the housing 138. Moreover, the noise attenuation structure 146 includes a damping material 150 disposed within each of the silencer panels 148, wherein the silencer panels 148 have a hollow configuration to receive the damping material 150 therein.

In an embodiment, the damping material 150 provided within the silencer panels 148 may be Rockwool. However, it should be noted that Rockwool disclosed herein is merely exemplary in nature and hence, non-limiting of this disclosure. Other types of damping materials are commonly known to one skilled in the art and may readily be implemented in lieu of the Rockwool disclosed herein.

FIG. 3 illustrates a front sectional view of the engine enclosure 100 showing internal details of the assembly 136 according to an embodiment of the present disclosure. The assembly 136 further includes a hollow tube 152 disposed within the noise attenuation structure 146. The hollow tube 152 extends from one of the sidewalls 140 to the ceiling 118 of the engine enclosure 100 so that an end 154 of the hollow tube 152 is disposed above the fan 124.

In the illustrated embodiment of FIGS. 2 and 3, the end 154 of the hollow tube 152 is rigidly connected to a cross member 156 of the framework 144. Moreover, another end 158 of the hollow tube 152 is rigidly connected to a top surface 160 of the framework 144 by a support member 162. Upon assembly 136 of the housing 138, the noise attenuation structure 146, and the hollow tube 152, the end 158 of the hollow tube 152 may be disposed proximal to the sidewall 140 of the housing 138.

Moreover, the assembly 136 further includes a harnessing mechanism 164. The harnessing mechanism 164 includes a flexible link 166 that is disposed proximate to the hollow tube 152. The harnessing mechanism 164 is operable to suspend the flexible link 166 into the hollow tube 152 to allow a releasable engagement between the flexible link 166 and the fan 124. As such, the hollow tube 152 is sized and shaped to allow passage of the flexible link 166 therethrough.

In an embodiment, the harnessing mechanism 164 is a block and tackle assembly 136. With reference to the present disclosure, the tackle and the flexible link 166 are regarded as the same component and hence, will be hereinafter referred to as “the flexible link 166”). Also, it may be noted that a type of the flexible link used may vary depending upon specific requirements of an application. In various embodiments of the present disclosure, the flexible link 166 may be implemented by way of structures such as, but not limited to, ropes, chains, or belts.

Although it is disclosed that the housing 138 is supported on the framework 144 having a polyhedral structure, it may be optionally contemplated to support the housing 138 directly on top of the ceiling 118 and configure the hollow tube 152 to be retained within the silencer panels 148 or the housing 138. One of skill in the art may appreciate that the hollow tube 152 could be integrally formed with those silencer panels 148 that are disposed directly above the corresponding fans 124a, 124b, 124c, or 124d thereby omitting the framework 144 altogether and/or some portions of the framework's polyhedral structure.

A manner of using the assembly 136 will be explained hereinafter in conjunction with FIGS. 1, 2, 3 and 4. As disclosed earlier herein, the assembly 136 may be used to provide support during a movement of the fans 124 relative to the engine enclosure 100.

Referring to FIGS. 1, 2, 3, and 4, in order to disassemble the fan 124 from the ceiling 118 of the engine enclosure 100, a technician may enter the engine enclosure 100 and remove the bolt 132 (See FIG. 2) connecting the fan 124 and the motor 134 (See FIG. 3). The technician may accomplish the removal of the bolt 132 by hand and/or with the help of suitable tools such as, but not limited to, a wrench, an Allen key, and the like. Optionally, in some cases as with typical installations, if the fan 124 is associated with a shroud (not shown) that is located below the ceiling and disposed about the motor 134, the shroud may be removed prior to removing the bolt 132.

As the bolt 132 is located above a plane in which blades 168 of the fan 124 are located, the technician may have to manually access the bolt 132 by passing his hands between adjacent blades 168 of the fan 124. However, one of ordinary skill in the art will acknowledge that assembly 136 or disassembly 136 routines are typically performed or carried out when the fan 124 is in an “OFF” state or in a non-operational state. Moreover, with regards to accessibility of the bolt 132 by the technician, it will be appreciated that the fan 124 is sized and/or shaped such that a gap G present between adjacent blades 168 of the fan 124 is sufficiently large for passage of the hands of the technician therethrough.

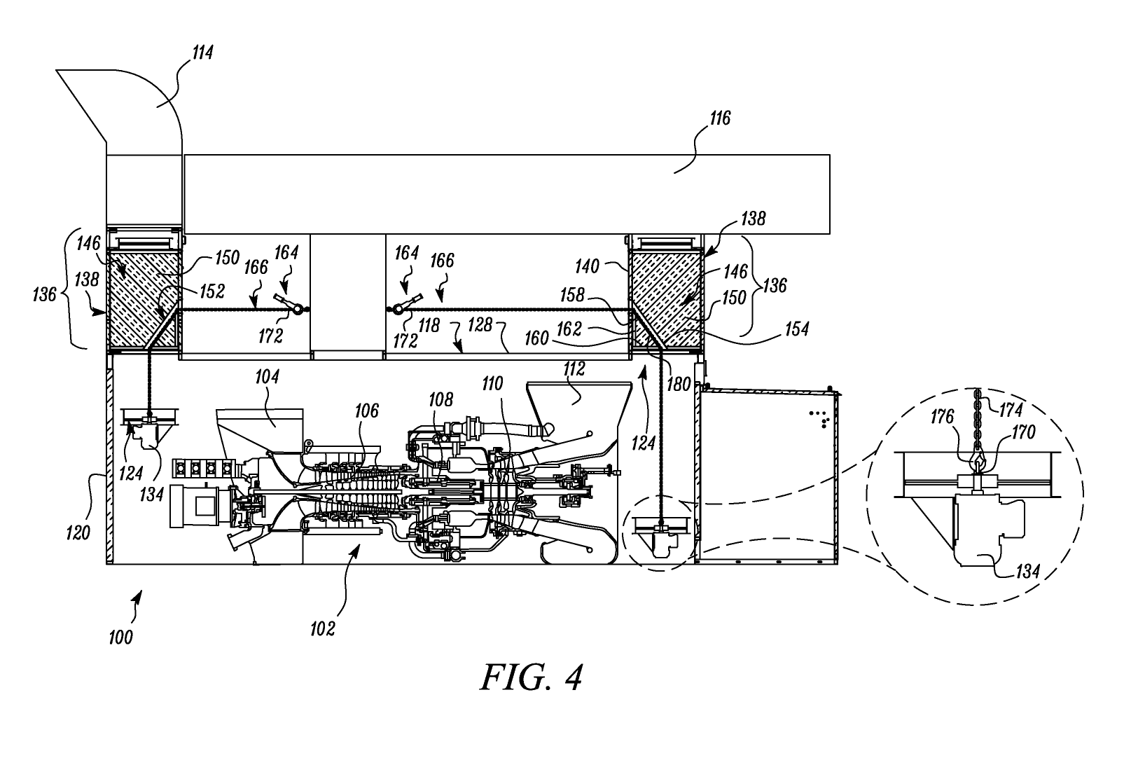

In an embodiment, the assembly 136 further includes an anchoring element 170 (See FIG. 4) that may be selectively coupled to the fan 124. The technician may couple the anchoring element 170 to the fan 124 after removal of the bolt 132 i.e., the anchoring element 170 may take place of the bolt 132. The anchoring element 170 may be, for example, but not limited to, an eye bolt, an anchor bolt, or any other type of structure that includes a member laterally disposed to an axis of gravity A-A′ acting on the fan 124.

Moreover, as shown in FIG. 3, the flexible link 166 includes a first end 172 and a second end 174. The first end 172 is configured to allow an effort to be applied thereto. The second end 174 is configured to releasably connect with the fan 124. In the illustrated embodiment of FIGS. 3 and 4, the second end 174 of the flexible link 166 is provided with a hook 176. The technician may couple the hook 176 to the anchoring element 170 coupled to the fan 124. Upon coupling the hook 176 to the anchoring element 170, it may be beneficially contemplated to keep the flexible link 166 sufficiently taut so that the harnessing mechanism 164 may tend to support a weight of the fan 124 and the motor 134.

Upon coupling the hook 176 to the anchoring element 170, the technician may now unfasten the bolts 130 that are in threaded engagement with the nuts 126 disposed on the top surface 128 of the ceiling 118 (See FIG. 2). Unfastening of the bolts 130 from the nuts 126 may allow the detachment of the fan 124 from the ceiling 118. At this point, the fan 124 may be suspended by the harnessing mechanism 164 by way of the flexible link 166, the hook 176, and the anchoring element 170 connected to the fan 124.

As shown in FIG. 4, the flexible link 166 may now be reeled out to lower the fan 124 relative to the ceiling 118 and/or move the fan 124 relative to the engine enclosure 100. The foregoing disclosure explains the manner of using the assembly 136 in connection with a process of disassembling the fan 124 from the ceiling 118 of the engine enclosure 100. However, it should be understood that similar steps may be performed in the reverse order to configure the second end 174 of the flexible link 166 to accomplish hoisting of the fan 124 relative to the ceiling 118.

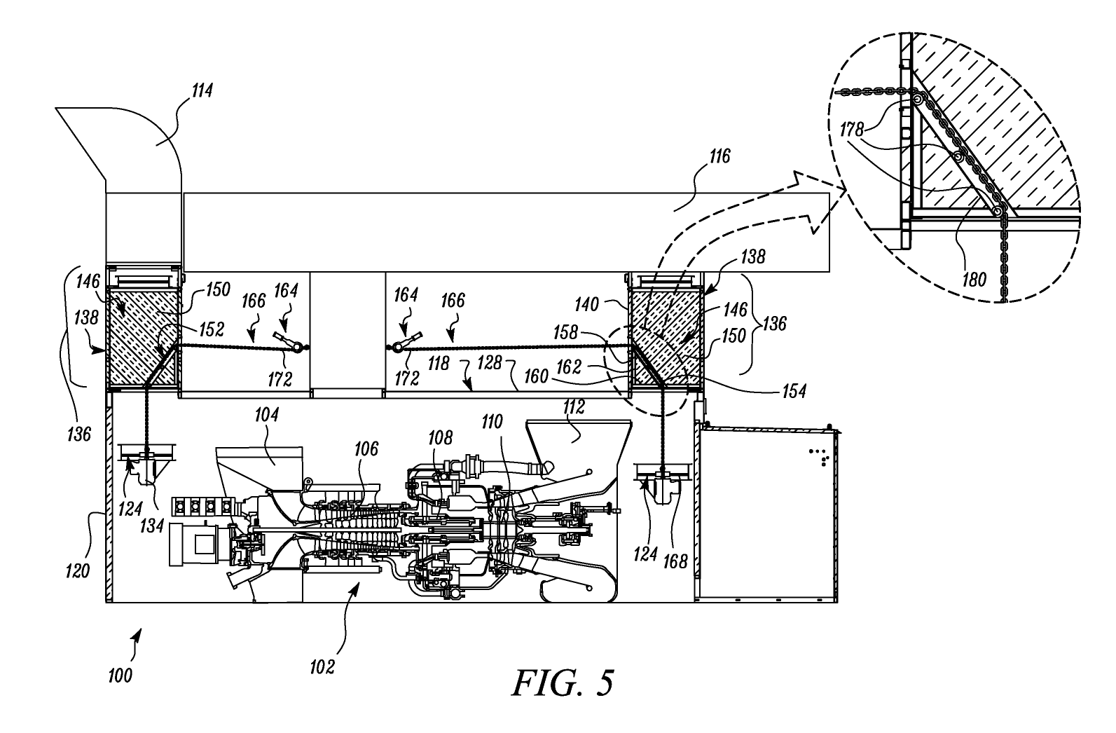

In an embodiment as shown in FIG. 5, the assembly 136 may further include bearings 178 disposed within the hollow tube 152. The bearings 178 may be for e.g., but not limited to, roller bearings 178. The bearings 178 may be configured to slidably support the flexible link 166 thereon. It is envisioned that as the fan 124 and the motor 134 are suspended by way of the flexible link 166, the hook 176, and the anchoring element 170, a weight of the fan 124 and the motor 134 may tend to bias the flexible link 166 against ends 172, 174 and/or a lower surface 180 of the hollow tube 152. The bearings 178 disclosed herein may reduce an amount of sliding friction with the flexible link 166 and hence, assist a movement of the flexible link 166 within the hollow tube 152.

Although, bearings 178 are disclosed herein, it may be noted that the bearings 178 are non-limiting of this disclosure. One of ordinary skill in the art will acknowledge that it can be optionally contemplated to provide other structures and/or suitably modify the geometry of the hollow tube 152 so as to provide sliding support to the flexible link 166 and facilitate smooth movement of the flexible link 166 during operation.

With reference to the accompanying drawings, the harnessing mechanism 164 is shown to be mounted on or coupled to a rigid support surface that is integral to the engine enclosure 100 so as to represent a single entity with the engine enclosure 100. However, it will be appreciated that the harnessing mechanism 164 can alternatively be a portable or a plug-and-play type of system in relation to the engine enclosure 100. Such a portable or a plug-and-play type of harnessing mechanism 164 may be used only when it is required to move, i.e., hoist or lower the fan 124 and the motor 134 relative to the engine enclosure 100.

Numerous systems are known in the art that provide flexible links with varying lengths and allow reeling-out and reeling-in of the flexible link. The harnessing mechanism 164 of the present disclosure may be readily implemented by way of such systems. Moreover, other simplified systems such a mere rope, a chain, or a cable may be suspended within the hollow tube 152 and coupled to the anchoring element 170. For the purposes of the present disclosure, it may be noted that such systems are also to be construed as falling within the scope of the harnessing mechanism 164 disclosed herein.

In another aspect of the present disclosure, the assembly 136 may be at least partly implemented by way of a first-class lever that is formed in at least one of the ceiling 118 and a structure disposed above the ceiling 118. For instance, with reference to the foregoing disclosure, the hollow tube 152 may be regarded as a fulcrum of the first-class lever. However, one of ordinary skill in the art may contemplate various other shapes/configurations/structures to form a first-class lever in or about the engine enclosure 100.

In one embodiment, the first-class lever may be formed in the ceiling 118 itself. In another embodiment, the first-class lever may be formed in a structure that is disposed immediately above the opening 122 defined in the ceiling 118. For instance, the noise attenuation structure 146 disclosed in the foregoing disclosure may be used as the structure in which the first-class lever may be formed.

Moreover, the first-class lever could include a first side and a second side, wherein the second side is located proximal to the opening 122 defined in the ceiling 118. The first end 172 of the flexible link 166 may be disposed at the first side of the first-class lever while the second end 174 of the flexible link 166 may be disposed at the second side of the flexible link 166. The first end 172 is configured to allow an effort to be applied thereto. This effort may be a pulling force applied to the first end 172 in order to hoist the fan 124, and may be a simple reel-out of the flexible link 166 under the effect of gravity acting on the fan 124 in order to lower the fan 124 in relation to the ceiling 118. The second end 174 is configured to perform at least one of hoisting and lowering of the component relative to the ceiling 118 in response to the effort and based on a type of effort applied at the first end 172.

Various embodiments disclosed herein are to be taken in the illustrative and explanatory sense, and should in no way be construed as limiting of the present disclosure. All directional references (e.g., above, below, upper, lower, top, bottom, vertical, horizontal, inward, outward, radial, upward, downward, left, right, leftward, rightward, L.H.S, R.H.S, clockwise, and counter-clockwise) are only used for identification purposes to aid the reader's understanding of the present disclosure, and may not create limitations, particularly as to the position, orientation, or use of the devices and/or methods disclosed herein. Joinder references (e.g., attached, affixed, coupled, engaged, connected, and the like) are to be construed broadly. Moreover, such joinder references do not necessarily infer that two elements are directly connected to each other.

Additionally, all numerical terms, such as, but not limited to, “first”, “second”, “third”, or any other ordinary and/or numerical terms, should also be taken only as identifiers, to assist the reader's understanding of the various embodiments, variations and/or modifications of the present disclosure, and may not create any limitations, particularly as to the order, or preference, of any embodiment, variation and/or modification relative to, or over, another embodiment, variation and/or modification.

It is to be understood that individual features shown or described for one embodiment may be combined with individual features shown or described for another embodiment. The above described implementation does not in any way limit the scope of the present disclosure. Therefore, it is to be understood although some features are shown or described to illustrate the use of the present disclosure in the context of functional segments, such features may be omitted from the scope of the present disclosure without departing from the spirit of the present disclosure as defined in the appended claims.

### INDUSTRIAL APPLICABILITY

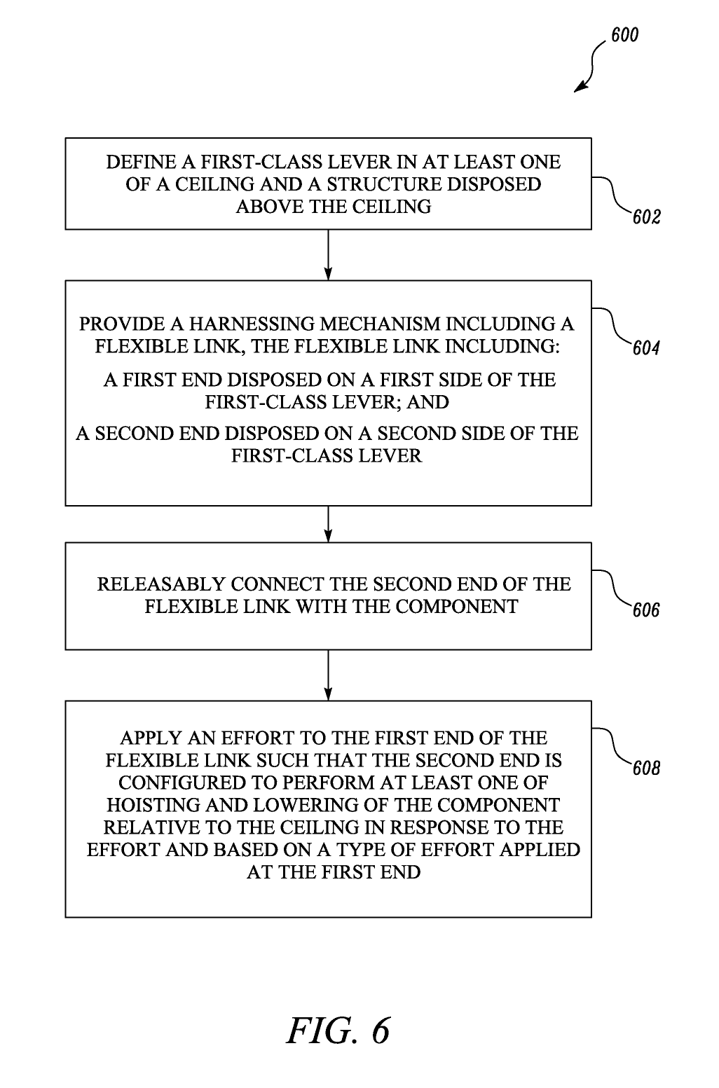

FIG. 6 illustrates a method 600 of moving a component relative to the ceiling 118 of the engine enclosure 100. Although embodiments of the present disclosure have been explained in conjunction with movement of the fan 124 and the motor 134, one of ordinary skill in the art will acknowledge that the present disclosure can be optionally used to hoist, lower, or move around other components that are typically encountered with engine enclosures and other allied industrial applications. These components may, in some cases, be large and/or heavy to be manually transported or carried from one location to another.

Moreover, these components may be configured for fitment in tight spaces allowing little or no flexibility to service personnel or technicians for accessing these components and undertaking the required operations on such components. Embodiments of the present disclosure offer a simplified assembly that can be easily formed in and around engine enclosures to accomplish various functions consistent with the present disclosure.

Referring to FIG. 6, at step 602, the method 600 of moving a component relative to the ceiling 118 of the engine enclosure 100 includes defining the first-class lever in at least one of the ceiling 118 and a structure disposed above the ceiling 118. In one embodiment as disclosed earlier herein, the first-class lever may be formed in the ceiling 118 itself. In another embodiment, the first-class lever may be formed in a structure that is disposed immediately above the opening 122 defined in the ceiling 118.

At step 604, the method 600 further includes providing the harnessing mechanism 164 including the flexible link 166, wherein the first end 172 of the flexible link 166 is disposed on the first side of the first-class lever while the second end 174 of the flexible link 166 is disposed on the second side of the first-class lever.

At step 606, the method 600 further includes releasably connecting the second end 174 of the flexible link 166 with the component. At step 608, the method 600 further includes applying an effort to the first end 172 of the flexible link 166 such that the second end 174 is configured to perform at least one of hoisting and lowering of the component relative to the ceiling 118 in response to the effort and based on the type of effort applied at the first end 172.

The present disclosure has applicability in transporting or moving components from one location to another. The assembly 136 disclosed herein may be advantageously implemented in applications where large and/or heavy components are to be moved. Moreover, as the assembly 136 is of a compact configuration with respect to its structure, the assembly 136 may be useful in locations that present tight spaces for movement of personnel and/or restriction to technicians in accessing the components. Therefore, with use of the assembly 136 disclosed herein, technicians may be able to easily and quickly perform various routines such as assembly 136, disassembly 136, service, or overhaul as required from time to time.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

What is claimed is:

1. A hoisting assembly for an engine enclosure having a ceiling and a fan mounted thereto, the ceiling having an opening configured for reception of the fan on the ceiling, the assembly comprising:
a housing having a plurality of sidewalls supported on a framework;
a noise attenuation structure disposed within the housing; and
a hollow tube disposed within the noise attenuation structure, the hollow tube extending from a sidewall to the opening in the ceiling, wherein an end of the hollow tube is disposed above the fan; and
a harnessing mechanism including a flexible link disposed proximate to the hollow tube, the harnessing mechanism operable to suspend the flexible link into the hollow tube to allow a releasable engagement between the flexible link and the fan.

2. The assembly of claim 1, wherein the harnessing mechanism is a block and tackle assembly.

3. The assembly of claim 1, wherein the hollow tube is sized and shaped to allow passage of the flexible link therethrough.

4. The assembly of claim 1, wherein the end of the hollow tube is rigidly connected to a cross member of the framework.

5. The assembly of claim 1, wherein an end of the hollow tube disposed proximal to the sidewall of the housing is rigidly connected to a top surface of the framework by a support member.

6. The assembly of claim 1 further including an anchoring element that is selectively coupled to the fan.

7. The assembly of claim 6, wherein the flexible link is provided with a hook configured to removably attach with the anchoring element.

8. The assembly of claim 1, wherein the noise attenuation structure includes:
a plurality of silencer panels spaced apart from one another and disposed in series within the housing; and
a damping material disposed in within each of the silencer panels.

9. The assembly of claim 8, wherein the damping material is Rockwool.

10. An assembly for moving a component relative to a ceiling of an engine enclosure, the ceiling having an opening configured for reception of the component thereabout on the ceiling, the assembly comprising:
a first-class lever formed in at least one of the ceiling and a structure disposed above the ceiling, the first-class lever having:
a first side; and
a second side located proximal to the opening defined in the ceiling; and
a harnessing mechanism including a flexible link, the flexible link including:
a first end disposed on the first side, wherein the first end is configured to allow an effort to be applied thereto; and
a second end disposed on the second side and configured to releasably connect with the component, wherein the second end is further configured to perform at least one of hoisting and lowering of the component relative to the ceiling in response to the effort and based on a type of effort applied at the first end.

11. The assembly of claim 10, wherein the structure is a noise attenuation and structure.

12. The assembly of claim 10, wherein the structure is enclosed within a housing having a plurality of sidewalls supported on a framework.

13. The assembly of claim 12, wherein the first-class lever is formed in the shape of a hollow tube disposed within the noise attenuation structure, the hollow tube extending from a sidewall to the ceiling, wherein an end of the hollow tube is disposed above the opening defined in the ceiling.

14. The assembly of claim 10, wherein the harnessing mechanism is a block and tackle assembly.

15. The assembly of claim 10, wherein the flexible link is one of a rope, a chain, and a belt.

16. The assembly of claim 10, wherein the first-class lever includes bearings therein, the bearings configured to slidably support the flexible link thereon.

17. A gas turbine engine including:
an enclosure;
a fan configured to mount to the ceiling of the enclosure; and
employing the assembly of claim 10.

18. A method of moving a component relative to a ceiling of an engine enclosure, the ceiling having an opening configured for reception of the component thereabout on the ceiling, the method comprising:
defining a first-class lever in at least one of the ceiling and a structure disposed above the ceiling;
providing a harnessing mechanism including a flexible link, the flexible link including:
a first end disposed on a first side of the first-class lever; and
a second end disposed on a second side of the first-class lever,
releasably connecting the second end of the flexible link with the component; and
applying an effort to the first end of the flexible link, wherein the second end is configured to perform at least one of hoisting and lowering of the component relative to the ceiling in response to the effort and based on a type of effort applied at the first end.

19. The method of claim 18 further including locating the second side of the first-class lever proximal to the opening defined in the ceiling.

20. The method of claim 18, wherein the structure is a noise attenuation structure.
